(19) United States
(12) Patent Application Publication
(10) Pub. No.: US 2014/0001926 A1
(43) Pub. Date: Jan. 2, 2014

(54) ASSEMBLING STRUCTURE FOR RESOLVER AND MOTOR ASSEMBLY HAVING THE SAME

(71) Applicant: SAMSUNG ELECTRO-MECHANICS CO., LTD., Suwon (KR)

(72) Inventors: Yong Wan Cho, Suwon (KR); Kwang Hyun Lee, Suwon (KR); Guen Hong Lee, Suwon (KR); Chang Hwan Choi, Suwon (KR); Changsung Sean Kim, Suwon (KR)

(73) Assignee: SAMSUNG ELECTRO-MECHANICS CO., LTD., Suwon (KR)

(21) Appl. No.: 13/895,071

(22) Filed: May 15, 2013

(30) Foreign Application Priority Data
Jun. 29, 2012 (KR) 10-2012-0071106

(51) Int. Cl. H02K 11/00

(52) U.S. Cl. CPC H02K 11/0015
USPC 310/68 B

(57) ABSTRACT

Disclosed herein is an assembling structure for a resolver capable of improving precision in sensing a position of a rotor of a motor by stably coupling and fixing a resolver stator part. More specifically, a fixing ring is coupled to the resolver stator part, a first coupling part of a motor housing, and a second coupling part of a cover member so as to simultaneously contact three surfaces of the resolver stator part, the first coupling part, and the second coupling part to form a stable coupling structure among the resolver stator part, the first coupling part, and the second coupling part, thereby making it possible to secure precision of a coupling position of the resolver stator part.

### CROSS REFERENCE TO RELATED APPLICATION

This application claims the benefit of Korean Patent Application No. 10-2012-0071106, filed on Jun. 29, 2012, entitled “Assembling Structure for Resolver and Motor Assembly Having the Same”, which is hereby incorporated by reference in its entirety into this application.

### BACKGROUND OF THE INVENTION

1. Technical Field

The present invention relates to an assembling structure for a resolver and a motor assembly having the same.

2. Description of the Related Art

A switched reluctance motor (SRM) generally called an SR motor rotates a rotor using a reluctance torque according to a change in magnetic reluctance as described in Korean Patent Laid-Open Publication No. 10-2008-0026872. The switched reluctance motor has a low manufacturing cost, hardly requires maintenance, and has a permanent lifespan due to high reliability. The switched reluctance motor is configured to include: a stator part including a stator yoke and a plurality of stator salient poles protruding from the stator yoke; and a rotor part including a rotor core and a plurality of rotor salient poles protruding from the rotor core so as to face the stator salient poles and rotatably received in the stator part.

In various devices including this motor assembly, a resolver sensing an absolute position of a rotor of a motor may be assembled. Particularly, in order to perform a vector control of a synchronous motor or an induction motor that may be used in a hybrid vehicle, a motor controller should set a coordinate in synchronization with a position of a magnetic flux. Here, it is important to sense the absolute position of the rotor of the motor.

In the resolver that is a kind of transformer, when excited voltage is applied to primary windings (input side windings) and a shaft is rotated, a magnetic coupling coefficient is changed, such that voltage in which an amplitude of a carrier is changed is generated in each of the secondary windings (output side windings). The windings are arranged so that this voltage is changed according to sine and cosine functions with respect to a rotation angle of the shaft.

Therefore, a rotation angle of the resolver may be recognized by sensing a carrier amplitude ratio between a sine output and a cosine output. The resolver operated by the above-mentioned principle is a sensor sensing velocity information and a phase of the motor to provide position information of the rotor as information for generating a torque command and a velocity command to the motor controller. Therefore, it is requisite to mount the resolver at an accurate position. For example, Japanese Patent Laid-Open Publication No. 2006-094582 discloses that a plurality of press-fitting parts are formed on an outer peripheral surface of a resolver stator to thereby be fixed to a motor case.

However, in an assembling structure for a resolver stator disclosed in Japanese Patent Laid-Open Publication No. 2006-094582 has a limitation in precisely manufacturing the plurality of press-fitting parts. In addition, the press-fitting part is formed in a portion of the resolver stator, such that distortion may be generated at the time of press-fitting.

Further, in a middle and large-sized motor in which the resolver is mounted, it is difficult to fixedly couple and fix a stator part of the resolver to a cover at an accurate position. Particularly, in a scheme of coupling the resolver stator to the cover using a screw according to the related art, the resolver stator has slipped due to lifting of the cover. To the contrary, when it was tried to prevent the lifting of the cover, a gap between a housing and the cover is generated, such that sealing is not performed along the gap.

### SUMMARY OF THE INVENTION

The present invention has been made in an effort to provide an assembling structure for a resolver capable of improving reliability in sensing an absolute position of a rotor of a motor by accurately coupling and fixing a resolver stator part mounted on a motor assembly, and a motor assembly having the same.

According to a preferred embodiment of the present invention, there is provided an assembling structure for a resolver including: a shaft forming the driving center of a motor; a resolver rotor part rotatably coupled to the shaft; a resolver stator part spaced apart from the resolver rotor part and formed so as to face the resolver rotor part in a radial direction; a motor housing having a first coupling part formed so as to support one surface of the resolver stator part in an axial direction; a cover member having a second coupling part formed so as to support the other surface of the resolver stator part in the axial direction; and a fixing ring coupled to the resolver stator part, the first coupling part, and the second coupling part so as to contact the resolver stator part, the first coupling part, and the second coupling part, respectively.

The fixing ring may be coupled and fixed to an outer surface of the resolver stator part in the radial direction, a first tapered surface of the first coupling part, and a second tapered surface of the second coupling part so as to simultaneously contact the outer surface of the resolver stator part in the radial direction, the first tapered surface of the first coupling part, and the second tapered surface of the second coupling part.

The fixing ring may be made of an elastic member.

The fixing ring may be an O-ring or a wave ring.

The fixing ring may have a circular ring shape.

According to another preferred embodiment of the present invention, there is provided a motor assembly including: a shaft forming the driving center of a motor; a rotor part rotatably coupled to the shaft; a bearing part coupled to a lower portion of the rotor part in an axial direction; a resolver rotor part coupled to the shaft and formed at a lower portion of the bearing part in the axial direction; a resolver stator part spaced apart from the resolver rotor part and formed so as to face the resolver rotor part; a motor housing having a first coupling part formed so as to support one surface of the resolver stator part and enclose an outer peripheral surface of the motor; a cover member having a second coupling part formed so as to support the other surface of the resolver stator part and coupled so as to cover one side end of the shaft in the axial direction; and a fixing ring coupled to and fixed to the resolver stator part, the first coupling part, and the second coupling part so as to face the resolver stator part, the first coupling part, and the second coupling part, respectively.

The rotor part may include an annular rotor core and a plurality of rotor poles protruding outwardly from the rotor core.

The motor assembly may further include a stator part, wherein the stator part may include: a stator yoke receiving the rotor part therein; and a stator pole spaced apart from the rotor pole so as to correspond to the rotor pole and protruding inwardly of the stator yoke.

The fixing ring may be coupled and fixed to an outer surface of the resolver stator part in the radial direction, a first tapered surface of the first coupling part, and a second tapered surface of the second coupling part so as to simultaneously contact the outer surface of the resolver stator part in the radial direction, the first tapered surface of the first coupling part, and the second tapered surface of the second coupling part.

The fixing ring may be made of an elastic member.

The fixing ring may be an O-ring or a wave ring.

The fixing ring may have a circular ring shape.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a partial cross-sectional view of a motor assembly according to a preferred embodiment of the present invention;

FIG. 2 is an enlarged cross-sectional view of a portion to which a resolver assembly of the motor assembly according to the preferred embodiment of the present invention is coupled;

FIG. 3 is a perspective view of a fixing ring according to the preferred embodiment of the present invention; and

FIG. 4 is a cross-sectional view showing a state in which a rotor part and stator part of the motor assembly according to the preferred embodiment of the present invention are coupled to each other.

### DESCRIPTION OF THE PREFERRED EMBODIMENTS

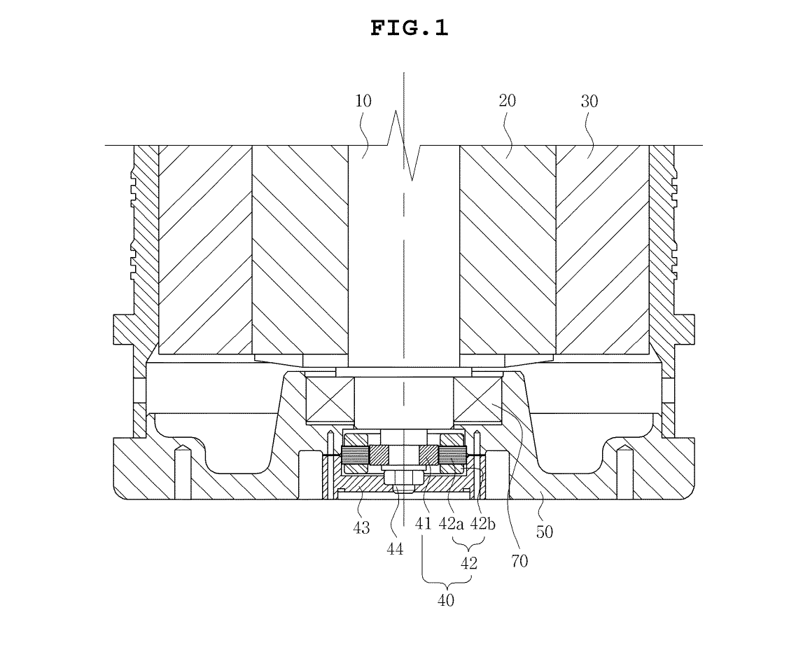

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the terms “first”, “second”, “one surface”, “the other surface” and so on are used to distinguish one element from another element, and the elements are not defined by the above terms. In addition, in the present invention, “an axial direction” refers to a direction in which a shaft shown in FIG. 1 is formed in a length direction, and “a radial direction” refers to a direction perpendicular to the axial direction. In describing the present invention, a detailed description of related known functions or configurations will be omitted so as not to obscure the gist of the present invention.

Hereinafter, exemplary embodiments of the present invention will be described in detail with reference to the accompanying drawings.

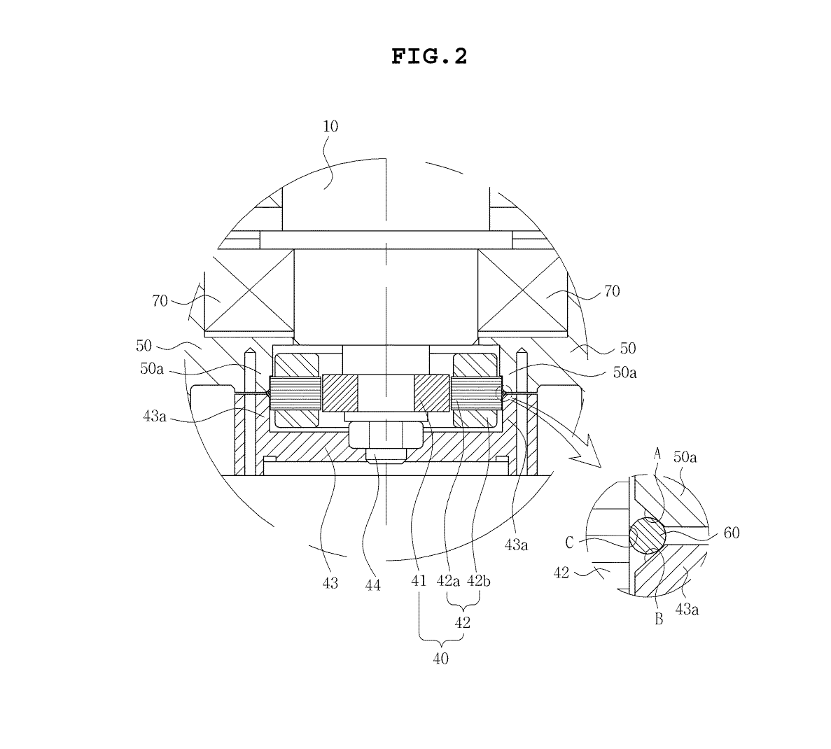

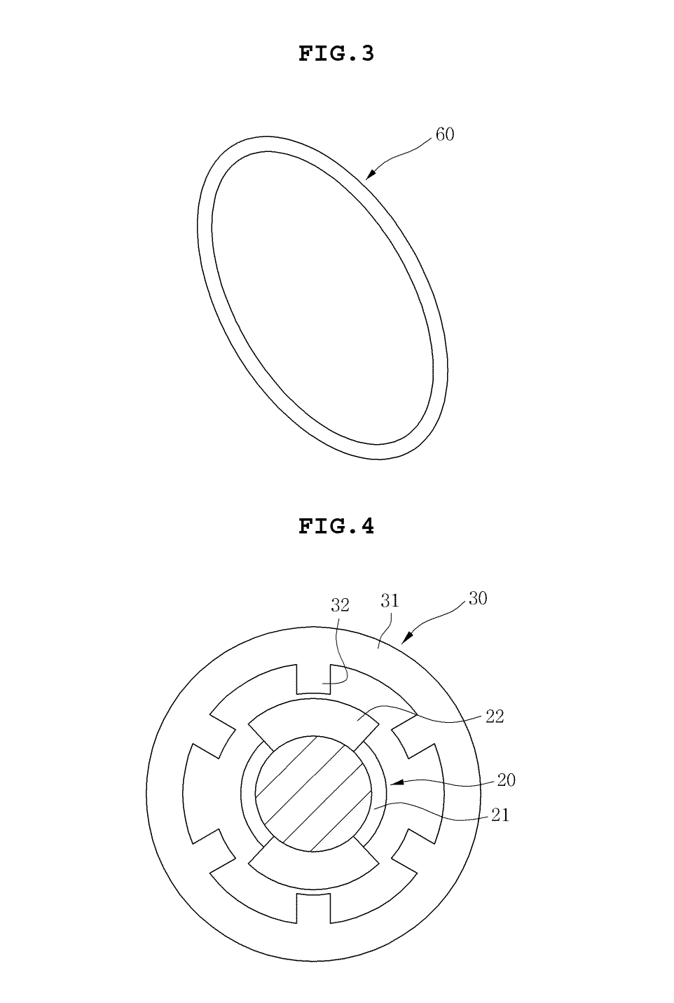

FIG. 1 is a partial cross-sectional view of a motor assembly according to the present invention; FIG. 2 is a partially enlarged cross-sectional view of an assembling structure for a resolver of the motor assembly according to a preferred embodiment of the present invention is coupled; FIG. 3 is a perspective view of a fixing ring according to the preferred embodiment of the present invention; and FIG. 4 is a cross-sectional view showing a state in which a rotor part and stator part of the motor assembly according to the preferred embodiment of the present invention are coupled to each other.

The assembling structure for a resolver according to the preferred embodiment of the present invention may be configured to include a shaft 10 forming the driving center of a motor, a resolver rotor part 41 rotatably coupled to the shaft 10, a resolver stator part 42 formed so as to be spaced apart from the resolver rotor part 41 and face the resolver rotor part 41 in the radial direction, a motor housing 50 having a first coupling part 50a formed so as to support one surface of the resolver stator part 42 in the axial direction, a cover member 43 having a second coupling part 43a formed so as to support the other surface of the resolver stator part 42 in the axial direction, and a fixing ring 60 coupled to each of the resolver stator part 42, the first coupling part 50a, and the second coupling part 43a so as to contact each of the resolver stator part 42, the first coupling part 50a, and the second coupling part 43a.

The shaft 10 forms a center axis around which the motor rotates. A resolver sensor, which senses an absolute position of a rotor at the time of driving of the motor, may be coupled to one end of the shaft 10 forming the driving center of the motor. A description of the entire configuration of the motor assembly including the shaft 10 will be provided below.

The resolver rotor part 41 may be rotatably coupled to the shaft 10. The resolver rotor part 41 has a hollow shape so as to be coupled to the shaft 10 and is coupled to the shaft 10 to rotate together with the shaft 10. The resolver rotor part 41 rotates together with shaft 10 at the time of the driving of the motor, thereby making it possible to sense the absolute position of the rotor of the motor through interaction with the resolver stator part 42. Particularly, the present invention relates to the assembling structure of the resolver rotor part 41 coupled to the shaft 10 and the resolver stator part 42 to the motor assembly. The resolver rotor part 41 is coupled to the shaft 10, thereby making it possible to secure precision of the coupling position or reliability of the coupling. However, in the resolver stator part 42 spaced apart from the resolver rotor part 41 in the radial direction, it is structurally difficult to maintain the precision of the coupling position. Therefore, the present invention suggests a new coupling structure of the resolver stator part 42 as described below.

The resolver stator part 42 is spaced apart from the resolver rotor part 41 to face the resolver rotor part 41 in the radial direction. The resolver stator part 42 may include a resolver stator core 42a and a stator salient pole (not shown) having a winding coil 42b wound therearound. According to the prior art, when the resolver stator part 42 is coupled to the motor housing 50 or the cover member 43, the resolver stator part 42 was not fixedly coupled to the motor housing 50 or the cover member 43 at an accurate position. Therefore, the present invention suggests a coupling structure including the fixing ring 60 so that the motor housing 50, the cover member 43, and the resolver stator part 42 may be simultaneously fixedly coupled to each other at an accurate position. A detailed description of the structure including the fixing ring 60 will be provided below.

The motor housing 50 may be formed so as to enclose the entire motor assembly including the resolver assembly. As shown in FIG. 1, the motor housing 50 may be formed so as to enclose a rotor part 20 and a stator part 30 of the motor assembly. Particularly, as shown in FIG. 2, in forming the resolver assembly, the motor housing 50 may support the resolver stator part 42 in the axial direction. The motor housing 50 may be provided with the first coupling part 50a supporting one surface of the resolver stator part 42 in the axial direction. The resolver stator part 42A may be supported by the first coupling part 50a of the motor housing 50 in the axial direction and be coupled to a cover member 43 to be described below so as to face the cover member 43 to thereby be fixed thereto.

The cover member 43 may be coupled to the motor housing 50 through a coupling screw 44 in the axial direction so as to enclose a resolver rotor part 41 and the resolver stator part 42. The cover member 43 may include the second coupling part 43a formed at an outer side end thereof in order to support the resolver stator part 42 in the axial direction. The second coupling part 43a may be coupled to the first coupling part 50a of the motor housing 50 described above so as to face the first coupling part 50a. Particularly, the second coupling part 43a is coupled to a fixing ring 60 to be described below so as to contact the fixing ring 60, thereby making it possible to firmly fix the resolver stator part 42, together with the first coupling part 50a.

The fixing ring 60 may be coupled to the resolver stator part 42, the first coupling part 50a of the motor housing 50, and the second coupling part 43a of the cover member 43 so that three surfaces thereof corresponding to the resolver stator part 42, the first coupling part 50a of the motor housing 50, and the second coupling part 43a of the cover member 43 contact the resolver stator part 42, the first coupling part 50a of the motor housing 50, and the second coupling part 43a of the cover member 43, as shown in a partially enlarged cross-sectional view of FIG. 2. Particularly, the fixing ring 60 may be an O-ring or a wave ring and be made of an elastic member to more stably fix the resolver stator part 42. As the elastic member, an elastic rubber or other various materials may be selected. As shown in FIG. 2, the fixing ring 60 is coupled to one end surface C of the resolver stator part 42, a first tapered surface A is formed at the first coupling part 50a, and a second tapered surface B is formed at the second coupling part 43a, such that coupling force among the resolver stator part 42, the motor housing 50, and the cover member 43 may be maintained to be appropriately balanced through the fixing ring 60. That is, one end surface C of the resolver stator part 42, the first tapered surface A, and the second tapered surface B contact corresponding surfaces of the fixing ring 60 in three directions, respectively, to support the fixing ring 60, such that force applied to the resolver stator part 42 is maintained to be appropriately balanced, thereby making it possible to improve the precision in fixing the coupling position of the resolver stator part 42. As shown in FIG. 3, the fixing ring 60 may be manufactured in a circular ring shape. The fixing ring is manufactured in a continuous ring shape, such that balanced supporting force may be maintained along an outer peripheral surface of the resolver stator part 42.

The motor assembly according to the preferred embodiment of the present invention may include the above-mentioned assembling structure for a resolver. More specifically, the motor assembly according to the preferred embodiment of the present invention may be configured to include the shaft 10 forming the driving center of the motor; the rotor part 20 rotatably coupled to the shaft 10; a bearing part 70 coupled to a lower portion of the rotor part 20 in the axial direction; the resolver rotor part 41 coupled to the shaft 10 and formed at a lower portion of the bearing part 70 in the axial direction; the resolver stator part formed so as to be spaced apart from the resolver rotor part 41 and face the resolver rotor part 41; the motor housing 50 having the first coupling part 50a formed so as to support one surface of the resolver stator part 42 and enclose an outer peripheral surface of the motor; the cover member 43 having the second coupling part 43a formed so as to support the other surface of the resolver stator part 42 and coupled so as to cover one side end of the shaft 10 in the axial direction; and the fixing ring 60 coupled and fixed to the resolver stator part 42, the first coupling part 50a, and the second coupling part 43a so as to face the resolver stator part 42, the first coupling part 50a, and the second coupling part 43a, respectively.

The shaft 10 forms the rotational center of the motor and is extended in the axial direction. Particularly, the axial direction in the present invention is based on a direction in which the shaft 10 is formed and refers to directions toward upper or lower portions based on the shaft 10 shown in FIG. 1. A rotor part 11 to be described below is coupled to the shaft 10 forming the rotation center of the motor.

As shown in FIGS. 1 and 4, the rotor part 20 may be configured to include an annular rotor core 21 and a plurality of rotor poles 22 protruding outwardly from the rotor core 21. The rotor core 21 has a hollow hole formed at a central portion thereof, and the shaft 10 is fixedly coupled to the hollow hole to transfer rotation of the rotor part 20 to the outside. A plurality of rotor poles 22 may be formed to protrude outwardly along an outer peripheral surface of the rotor core 21 and be formed to correspond to stator salient poles 32 to be described below.

A stator part 30 is configured to include a stator yoke 31 and stator salient poles 32, as shown in FIG. 4. The stator yoke 31 may include a hollow hole formed so as to receive the rotor part 20 therein, and a plurality of stator salient poles 32 may be formed to protrude at an inner surface of the stator yoke 31 and correspond to the rotor poles 22 of the rotor part 20. Current is applied to the stator salient poles 32 of the stator yoke 31 to form a magnetic flux path through the stator salient poles 32 and the rotor poles 22 of the rotor part 20 facing the stator salient poles 32, such that the rotor part 20 rotates.

The bearing part 70 is a component rotating the rotor part 20 while supporting weight in the axial direction in the shaft 10 including the rotating rotor part 20 and a load applied to the shaft 10. The bearing part 70 is coupled to one side of the rotor part 20 in the axial direction and is positioned in the motor housing 50 described above. Although not shown, the bearing parts 70 may be formed at upper and lower portions in the axial direction, respectively.

A description of each of the configurations of the resolver rotor part 41 and the resolver stator part 42 that configure the resolver, the coupling structure by the fixing ring 60, the motor housing 50, and the cover member 43 is overlapped with that of the assembling structure for a resolver according to the preferred embodiment of the present invention. Therefore, a detailed description thereof will be omitted.

As set forth above, according to the preferred embodiment of the present invention, precision of the coupling of the resolver stator part coupled to the motor assembly may be improved.

In addition, the reliability of the assembling among the resolver stator part coupled to the motor assembly, the housing, and the cover member is improved through the fixing ring to facilitate the assembling and the separation between the cover member and the housing, thereby making it possible to improve the operation performance of the entire motor assembly and the reliability of the coupling.

Further, the reliability of the coupling position of the resolver coupled to the motor assembly is improved, such that the position of the rotor according to the rotation of the motor assembly is more reliably sensed, thereby making it possible to secure the operation performance and the driving reliability in various devices using the motor assembly.

Furthermore, the fixing ring simultaneously contacting the motor housing, the cover member, and the resolver stator part is disposed thereamong to maintain the coupling among the motor housing, the cover member, and the resolver stator part so as to be balanced using the elastic force of the fixing member, thereby making it possible to improve the precision of the coupling position and the coupling among the motor housing, the cover member, and the resolver stator part.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An assembling structure for a resolver comprising:
a shaft forming the driving center of a motor;
a resolver rotor part rotatably coupled to the shaft;
a resolver stator part spaced apart from the resolver rotor part and formed so as to face the resolver rotor part in a radial direction;
a motor housing having a first coupling part formed so as to support one surface of the resolver stator part in an axial direction;
a cover member having a second coupling part formed so as to support the other surface of the resolver stator part in the axial direction; and
a fixing ring coupled to the resolver stator part, the first coupling part, and the second coupling part so as to contact the resolver stator part, the first coupling part, and the second coupling part, respectively.

2. The assembling structure for a resolver as set forth in claim 1, wherein the fixing ring is coupled and fixed to an outer surface of the resolver stator part in the radial direction, a first tapered surface of the first coupling part, and a second tapered surface of the second coupling part so as to simultaneously contact the outer surface of the resolver stator part in the radial direction, the first tapered surface of the first coupling part, and the second tapered surface of the second coupling part.

3. The assembling structure for a resolver as set forth in claim 1, wherein the fixing ring is made of an elastic member.

4. The assembling structure for a resolver as set forth in claim 1, wherein the fixing ring is an O-ring or a wave ring.

5. The assembling structure for a resolver as set forth in claim 1, wherein the fixing ring has a circular ring shape.

6. A motor assembly comprising:
a shaft forming the driving center of a motor;
a rotor part rotatably coupled to the shaft;
a bearing part coupled to a lower portion of the rotor part in an axial direction;
a resolver rotor part coupled to the shaft and formed at a lower portion of the bearing part in the axial direction;
a resolver stator part spaced apart from the resolver rotor part and formed so as to face the resolver rotor part;
a motor housing having a first coupling part formed so as to support one surface of the resolver stator part and enclose an outer peripheral surface of the motor;
a cover member having a second coupling part formed so as to support the other surface of the resolver stator part and coupled so as to cover one side end of the shaft in the axial direction; and
a fixing ring coupled to and fixed to the resolver stator part, the first coupling part, and the second coupling part so as to face the resolver stator part, the first coupling part, and the second coupling part, respectively.

7. The motor assembly as set forth in claim 6, wherein the rotor part includes an annular rotor core and a plurality of rotor poles protruding outwardly from the rotor core.

8. The motor assembly as set forth in claim 6, further comprising a stator part, wherein the stator part includes:
a stator yoke receiving the rotor part therein; and
a stator pole spaced apart from the rotor pole so as to correspond to the rotor pole and protruding inwardly of the stator yoke.

9. The motor assembly as set forth in claim 6, wherein the fixing ring is coupled and fixed to an outer surface of the resolver stator part in the radial direction, a first tapered surface of the first coupling part, and a second tapered surface of the second coupling part so as to simultaneously contact the outer surface of the resolver stator part in the radial direction, the first tapered surface of the first coupling part, and the second tapered surface of the second coupling part.

10. The motor assembly as set forth in claim 6, wherein the fixing ring is made of an elastic member.

11. The motor assembly as set forth in claim 6, wherein the fixing ring is an O-ring or a wave ring.

12. The motor assembly as set forth in claim 6, wherein the fixing ring has a circular ring shape.
